(19) United States
(12) Patent Application Publication
(10) Pub. No.: US 2025/0253699 A1
(43) Pub. Date: Aug. 7, 2025

(54) CHARGE FIELD-EFFECT TRANSISTOR LINEAR CHARGING REGULATOR

(71) Applicant: Cirrus Logic International Semiconductor Ltd., Edinburgh (GB)

(72) Inventors: Brendan T. DEEMS, Austin, TX (US); Anindya BHATTACHARYA, Austin, TX (US); Qi CAI, Austin, TX (US); Richard TURKSON, Pflugerville, TX (US); Eric J. KING, Austin, TX (US); William O. HADDEN, Austin, TX (US)

(73) Assignee: Cirrus Logic International Semiconductor Ltd., Edinburgh (GB)

(21) Appl. No.: 18/936,365

(22) Filed: Nov. 4, 2024

Related U.S. Application Data
(60) Provisional application No. 63/550,193, filed on Feb. 6, 2024.

(51) Int. Cl. H02J 7/00

(52) U.S. Cl. CPC H02J 7/007182; H02J 2207/20

(57) ABSTRACT

A charge field-effect linear charger for charging a battery may include a charge pump configured to drive a field-effect transistor external to the charge field-effect linear charger and a variable output impedance for the charge pump, the variable output impedance depending on a mode of operation of the charge field-effect linear charger and an impedance of the field-effect transistor.

### RELATED APPLICATION

The present disclosure claims priority to U.S. Provisional Patent Application Ser. No. 63/550,193, filed Feb. 6, 2024, which is incorporated by reference herein in its entirety.

### FIELD OF DISCLOSURE

The present disclosure relates in general to circuits for electronic devices, including without limitation personal audio devices such as wireless telephones and media players, and more specifically, charge field-effect transistor linear charging regulators for charging a battery.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

Such devices may include a battery management system, which may be implemented as a battery management integrated circuit (IC), for fuel gauging of a battery. A battery management system may include functionality to detect fault conditions in order to protect one or more cells of the battery. Being able to accurately sense such fault conditions is important so that a protection field-effect transistor (FET) is activated or deactivated at the appropriate or correct times. Such devices may also include charging circuitry configured to charge the battery. In some devices, charging circuitry may be integral to the battery management system.

Existing linear charging loops in battery management ICs exhibit a number of system-level problems. For example, existing approaches may be unable to support a wide range of capacitive loads or external field-effect transistors due to stability limitations. As another example, existing approaches may be unable to support a wide range current for linear charging due to accuracy and stability limitations. As a further example, existing approaches may be unable to support a regulation loop for regulating a minimum voltage for the charger for a wide range of system capacitors and charge currents. As an additional example, existing approaches may be unable to self-protect against high voltage transients. Accordingly, systems and methods that overcome these disadvantages may be desired.

### SUMMARY

In accordance with the teachings of the present disclosure, one or more disadvantages and problems associated with existing approaches to battery charging may be reduced or eliminated.

In accordance with embodiments of the present disclosure, a charge field-effect linear charger for charging a battery may include a charge pump configured to drive a field-effect transistor external to the charge field-effect linear charger and a variable output impedance for the charge pump, the variable output impedance depending on a mode of operation of the charge field-effect linear charger and an impedance of the field-effect transistor.

In accordance with these and other embodiments of the present disclosure, a method for charging a battery with a charge field-effect linear charger may include driving a field-effect transistor external to the charge field-effect linear charger with a charge pump of the charge field-effect linear charger and varying a variable output impedance for the charge pump depending on a mode of operation of the charge field-effect linear charger and an impedance of the field-effect transistor.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system for charging a battery, in accordance with embodiments of the present disclosure;

FIG. 2 illustrates a graph depicting example gains for selected components of a current regulation loop of the linear charging regulator of FIG. 1, in accordance with embodiments of the present disclosure;

FIG. 3 illustrates a graph depicting an example response of the current regulation loop of the linear charging regulator of FIG. 1, in accordance with embodiments of the present disclosure; and

FIG. 4 illustrates an example variable output impedance charge pump, in accordance with embodiments of the present disclosure.

### DETAILED DESCRIPTION

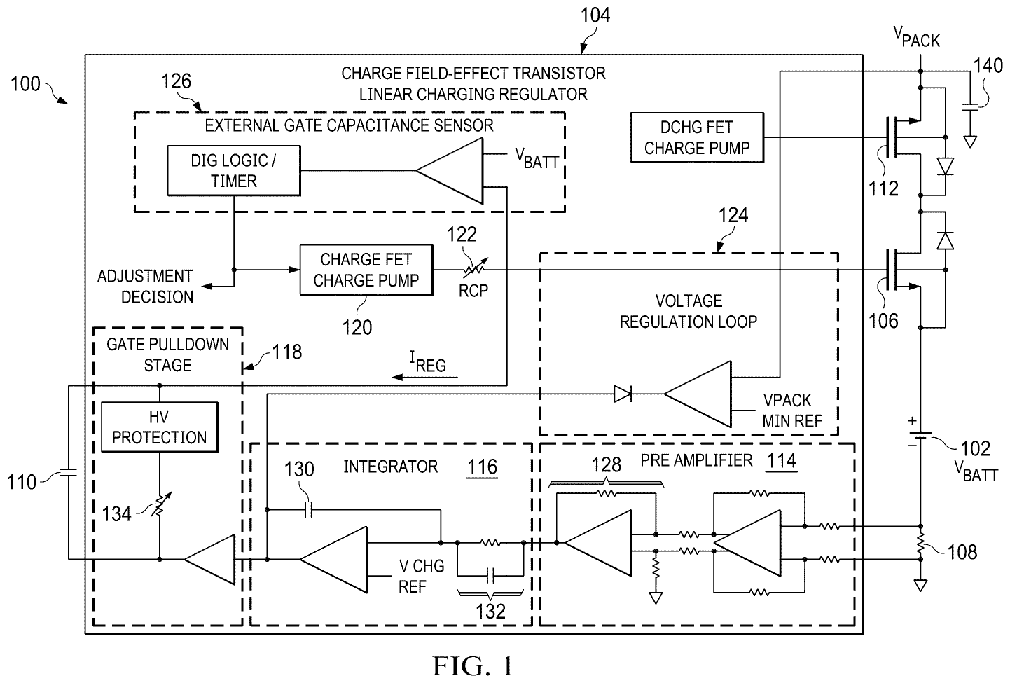

FIG. 1 illustrates an example system 100 for charging a battery 102, in accordance with embodiments of the present disclosure. As shown in FIG. 1, system 100 may include battery 102, a charge field-effect transistor (FET) linear charging regulator 104, a charging protection FET 106, a sense resistor 108, a feedforward capacitor 110, and a discharging protection FET 112.

Battery 102 may include any system, device, or apparatus configured to convert chemical energy stored within battery 102 to electrical energy. For example, in some embodiments, battery 102 may be integral to a portable electronic device and battery 102 may be configured to deliver electrical energy to components of such portable electronic device. Further, battery 102 may also be configured to recharge, in which it may convert electrical energy received by battery 102 into chemical energy to be stored for later conversion back into electrical energy. As an example, in some embodiments, battery 102 may comprise a lithium-ion battery.

Charging regulator 104 may include any system, device, or apparatus configured to implement a highly-configurable linear charging loop for regulating a charging current used to charge battery 102, as described in greater detail below. In some embodiments, charging regulator 104 may be integral to a battery management system, such as a battery management IC.

Charging protection FET 106 may include any suitable transistor which may be activated (e.g., turned on, closed, enabled, etc.) and deactivated (e.g., turned off, opened, disabled, etc.) in response to a control signal from charging regulator 104. Although FIG. 1 depicts only a single charging protection FET 106 for the purposes of clarity and exposition, it is understood that system 100 may include any suitable number of charging protection FETs 106.

Sense resistor 108 may comprise any suitable system, device, or apparatus for which a voltage across sense resistor 108 is substantially proportional to a current flowing through sense resistor 108, in accordance with Ohm's Law.

Feedfoward capacitor 110 may comprise any suitable system, device, or apparatus for which a voltage across feedforward capacitor 110 is substantially proportional to a charge accumulated across feedforward capacitor 110, in accordance with Coulomb's Law. Feedforward capacitor 110 may be used to achieve stability for the minimum voltage regulation loop for charger voltage V_{PACK} under a wide range of load scenarios. Although depicted in FIG. 1 as an external capacitor, in some embodiments feedforward capacitor 110 may be internal to an integrated circuit implementing charging regulator 104. In these and other embodiments, feedforward capacitor 110 may have a variable capacitance.

Discharging protection FET 112 may include any suitable transistor which may be activated (e.g., turned on, closed, enabled, etc.) and deactivated (e.g., turned off, opened, disabled, etc.) in response to a control signal from charging regulator 104. Although FIG. 1 depicts only a single discharging protection FET 112 for the purposes of clarity and exposition, it is understood that system 100 may include any suitable number of discharging protection FETs 112.

As shown in FIG. 1, charging regulator 104 my include a low-offset variable gain preamplifier 114, an integrator 116, a gate pull-down stage 118, a charge FET charge pump 120, a variable charge pump output impedance 122, a voltage regulation loop 124, and an external gate capacitance sensor 126.

Low-offset variable gain preamplifier 114 may be configured to sense a voltage across sense resistor 108, which may be indicative of current flowing through battery 102. Low-offset variable gain preamplifier 114 may recover gain lost from an external output stage for a wide range of current settings. Low-offset variable gain preamplifier 114 may include a differential-to-single-ended converter to convert the differential signal generated by the input stage of low-offset variable gain preamplifier 114 into a single-ended signal.

Integrator 116 may integrate the output of preamplifier 128. Integrator 116 may be implemented either as a continuous time or a switched capacitor integrator. A bandwidth of the loop of charging regulator 104 may be set by integrating capacitor 130, or in a switched capacitor implementation, by the bandwidth of the switched capacitor. Bandwidth of the loop may be set to ensure stability with the existence of other poles intrinsic to preamplifier 114. As shown in FIG. 1, integrator 116 may include an input parallel resistor-capacitor block 132 which may introduce a zero to compensate for a pole of the gate of charging protection FET 106. As also shown in FIG. 1, a charging current may be set by a variable charge reference voltage V_CHG_REF. In some embodiments, the charging current may instead be set by a buffered current source reference input.

Gate pull-down stage 118 may regulate a voltage on the gate of charging protection FET 106, and a strength of gate pull-down stage 118 may be varied by a variable source impedance 134 of gate pull-down stage 118. Gate pull-down stage 118 may also implement a transconductance stage designed to provide a load to the output of charge FET charge pump 120 with a controlled gain term to keep constant bandwidth across required gate voltages for different external FETs (e.g., charging protection FET 106) and charge currents.”

Charge FET charge pump 120 may include overvoltage protection and may be configured to handle high high-voltage transients present on charger voltage V_{PACK} and/or battery voltage VBATT. A variable charge pump output impedance 122 may be varied based on a mode of operation of charging regulator 104 (e.g., charging or discharging battery 102). A transconductance of a charging FET within charge FET charge pump 120 may also contribute to the current regulation loop, as such transconductance multiplied by the resistance of sense resistor 108 may provide a gain term of the loop.

Voltage regulation loop 124 may be configured to regulate charger voltage V_{PACK}. Voltage regulation loop 124 may include variable feedforward compensation and may support a wide range of external FET gate capacitances (e.g., charging protection FET 106) and capacitances on charger voltage V_{PACK} (e.g., capacitor 140). The bandwidth of voltage regulation loop 124 is sufficient to regulate the charger voltage V_{PACK} with reasonable undershoot under a wide range of capacitances of capacitor 140. The mechanism for getting a high accuracy loop fast enough to achieve this method of regulation is the feed forward capacitance of integrating capacitor 130. In operation, once charger voltage V_{PACK} falls below a set threshold voltage VPACK_MIN_REF, a summing node at the output of integrator 116 may be overdriven. During this overdriven condition, the input of integrator 116 may be pulled to the output of preamplifier stage 114. Once charger voltage V_{PACK} rises above set threshold voltage VPACK_MIN_REF, integrator 116 may resume regulating charging current I_{REG}.

External gate capacitance sensor 126 may be configured to sense the capacitance of external FET gate capacitance 110 via timing between the beginning of gate voltage rise and a time of settling. External gate capacitance sensor 126 may provide external compensation (shown as “ADJUSTMENT DECISION” in FIG. 1) allowing for high-frequency voltage regulation to protect charger voltage V_{PACK} from high transients during high current linear charging. For example, such adjustment decision may control parameters of variable charge pump output impedance 122 and/or variable source impedance 134 to account for error in user settings (e.g., user programmed gate cap to 3.5 nF, but 5 nF was sensed, and adjustments may be made for charge pump output impedance 122 and/or variable source impedance 134 to the 5 nF settings).

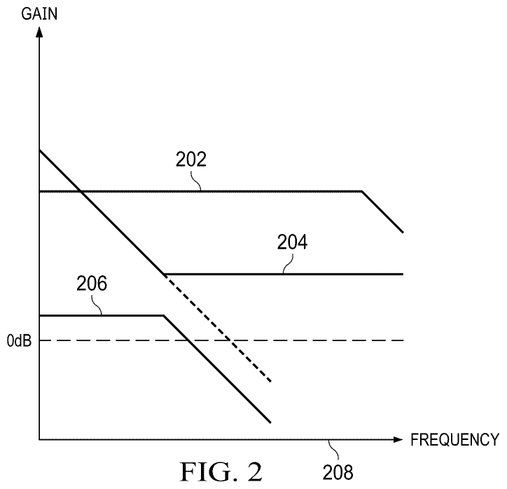

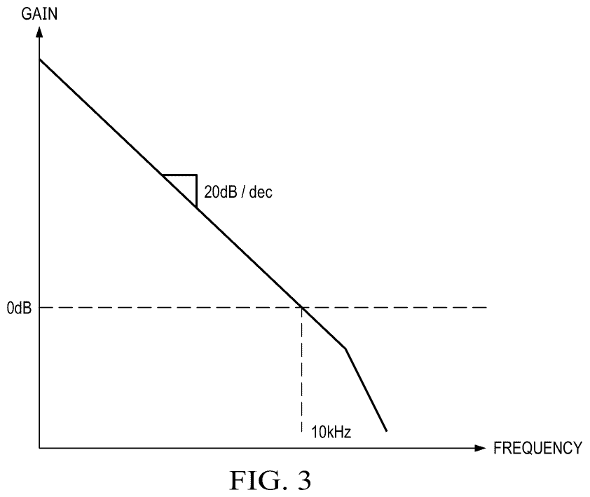

FIG. 2 illustrates a graph depicting example gains versus frequency for selected components of a current regulation loop of charging regulator 104, in accordance with embodiments of the present disclosure. In particular, FIG. 2 depicts: an example gain 202 versus frequency for preamplifier 114, an example gain 204 versus frequency for integrator 116, an example gain 206 versus frequency for the transconductance of gate pull-down stage 118, and an example gain 208 versus frequency for the transconductance of the charge FET of charge FET charge pump 120. These various components of gain may combine to result in the overall response of the current regulation loop depicted in FIG. 3.

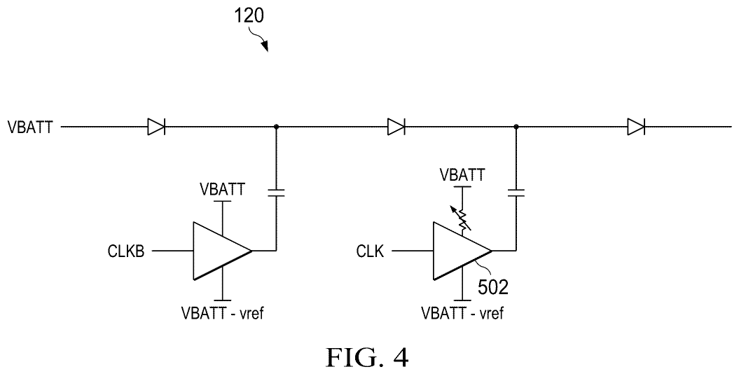

FIG. 4 illustrates an example variable output impedance charge pump 120, in accordance with embodiments of the present disclosure. A pull-up strength of final stage 502 of charge pump 120 may be chosen on the charge transfer phase side of the driver in order to limit charge transferred to its output and placing an external FET gate pole to a consistent frequency, as shown by waveform 206 in FIG. 2. A wide range of pull-up strengths may exist for a wide range of potential FET capacitances.

The systems and methods described herein may overcome the disadvantages of traditional approaches described in the Background section. For example, charging regulator 104 may regulate trickle charging for a deeply discharged battery 102, while also providing current and minimum voltage regulation. Charging regulator 104 may also be capable of high bandwidth with a very large range of capacitive loads or external charge FETs without compromising loop stability or performance. Charging regulator 104 may also achieve high accuracy across a large current range, as well as support a wide range of gain options for minimum charger voltage V_{PACK} while maintaining loop regulation and stability over a wide range of capacitance on the electrical node of charger voltage V_{PACK}, for example by decreasing regulated charging current when charger voltage V_{PACK} drops below a minimum threshold. Further, charging regulator 104 may provide protection against overvoltage conditions seen on either battery voltage VBATT or charger voltage V_{PACK}.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A charge field-effect linear charger for charging a battery, comprising:
a charge pump configured to drive a field-effect transistor external to the charge field-effect linear charger; and
a variable output impedance for the charge pump, the variable output impedance depending on a mode of operation of the charge field-effect linear charger and an impedance of the field-effect transistor.

2. The charge-field effect linear charger of claim 1, further comprising sensing circuitry for sensing a voltage across a sense resistor external to the charge field-effect linear charger and indicative of a current through the battery, the sensing circuitry comprising:
a variable gain amplifier having its inputs configured to couple to respective terminals of the sense resistor; and
an integrator configured to integrate an output of the variable gain amplifier.

3. The charge-field effect linear charger of claim 2, further comprising a feedforward compensation capacitor coupled at the output of the integrator and configured to provide feedforward compensation of a gate capacitance of the field-effect transistor.

4. The charge-field effect linear charger of claim 2, further comprising a pull-down stage coupled to the field-effect transistor and the output of the integrator and configured to regulate a voltage on a gate terminal of the field-effect transistor.

5. The charge-field effect linear charger of claim 4, wherein the pull-down stage includes a variable source impedance for varying a pull-down strength of the pull-down stage.

6. The charge-field effect linear charger of claim 5, wherein the variable source impedance is actively adapted based on capacitive sensing of a gate capacitance of the field-effect transistor.

7. A method for charging a battery with a charge field-effect linear charger, the method comprising:
driving a field-effect transistor external to the charge field-effect linear charger with a charge pump of the charge field-effect linear charger; and
varying a variable output impedance for the charge pump depending on a mode of operation of the charge field-effect linear charger and an impedance of the field-effect transistor.

8. The method of claim 7, further comprising sensing a voltage across a sense resistor external to the charge field-effect linear charger and indicative of a current through the battery using sensing circuitry, the sensing circuitry comprising:
a variable gain amplifier having its inputs configured to couple to respective terminals of the sense resistor; and
an integrator configured to integrate an output of the variable gain amplifier.

9. The method of claim 8, further comprising providing feedforward compensation of a gate capacitance of the field-effect transistor with a feedforward compensation capacitor coupled at the output of the integrator.

10. The method of claim 8, further comprising regulating a voltage on a gate terminal of the field-effect transistor with a pull-down stage coupled to the field-effect transistor and the output of the integrator.

11. The method of claim 10, further comprising varying a pull-down strength of the pull-down stage with a variable source impedance of the pull-down stage.

12. The method of claim 11, further comprising actively adapting the variable source impedance based on capacitive sensing of a gate capacitance of the field-effect transistor.
